(19) United States
(12) Patent Application Publication
(10) Pub. No.: US 2018/0144440 A1
(43) Pub. Date: May 24, 2018

(54) Providing Map Context

(71) Applicant: Microsoft Technology Licensing, LLC, Redmond, WA (US)

(72) Inventors: Felix GTI Andrew, Seattle, WA (US); Jeff West, Sammamish, WA (US); Geoffrey T. Ebersol, Seattle, WA (US)

(73) Assignee: Microsoft Technology Licensing, LLC, Redmond, WA (US)

(21) Appl. No.: 15/360,002

(22) Filed: Nov. 23, 2016

(51) Int. Cl. G06T 3/40; G06T 11/20; G06T 7/00; G06K 9/00; G06T 7/60; G06T 11/60

(52) U.S. Cl. CPC G06T 3/40; G06T 11/20; G06T 7/004; G06T 2200/24; G06T 7/60; G06T 11/60; G06T 2215/16; G06K 9/00476

(57) ABSTRACT

Map context for a target location is generated based on a familiarity of a user with an area surrounding the target location. A context map can be displayed at any of a number of zoom levels in order to provide context tailored to the user. Accordingly, if a user is unfamiliar with the area surrounding the target location the context map can be displayed at a zoom level that displays where in the world the target location is, such as displaying a map of a state, country, or group of countries. If the user is instead familiar with the target location, the context map can display the city, neighborhood, or street where the target location is located. Alternately, a radius around the target location can be used as the zoom level based on the familiarity of the user.

### BACKGROUND

Interacting on a global scale has become increasingly commonplace as many interactions occur online. However, with this ever increasing exposure to distant locations, people are often faced with unfamiliar locations. As such, a user viewing a map of a location on his or her device, may not be provided with useful details at a default zoom level of the map. This causes the user to have to make zoom level adjustments in order to achieve a desired level of detail to gain context for the location, and then return to the default zoom level in order to view the location. This interaction can be time consuming and frustrating for the user, leading to user dissatisfaction with their devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, an indication of a target location is received at a computing device. A familiarity of a user of the computing device with an area surrounding the target location is determined, and a zoom level for a map based on the familiarity of the user with the area around the target location is also determined. The map is displayed with the determined zoom level.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is a block diagram illustrating an example computing device implementing providing map context in accordance with one or more embodiments.

FIG. 2 is a flowchart illustrating an example process for providing map context in accordance with one or more embodiments.

FIG. 3 illustrates an example of providing map context in accordance with one or more embodiments.

FIG. 4 illustrates another example of providing map context in accordance with one or more embodiments.

FIG. 5 illustrates another example of providing map context in accordance with one or more embodiments.

FIG. 6 illustrates another example of providing map context in accordance with one or more embodiments.

FIG. 7 illustrates another example of providing map context in accordance with one or more embodiments.

FIG. 8 illustrates an example user interface in accordance with one or more embodiments.

FIG. 9 illustrates an example system that includes an example computing device that is representative of one or more systems and/or devices that may implement the various techniques described herein.

### DETAILED DESCRIPTION

Providing map context is described herein. The context can optionally be provided as a separate context map, allowing a user to quickly and easily contextualize a location (e.g., a location that is also displayed at a default zoom level on another map). In order to provide appropriate context information for a user and a location, the familiarity of the user with the location is determined and information is provided based on this level of familiarity.

The context map can be displayed at a zoom level determined based on the user's familiarity with the target location. If the user is determined to be unfamiliar with an area around the target location, the zoom level can be zoomed out to show, for example, a group of countries, a country, a state, a province, or any other entity to provide context to the user on where the target location is in the world. Alternately, if the user is determined to be familiar with the area, the context map might be, for example, a group of cities, a city, a neighborhood, a set distance radius around the target location, a number of blocks around the target location, or another level to provide context on where the target location is at a finer detailed level.

For instance, a user in Seattle, Wash. may be highly familiar with Seattle and the cities that immediately surround it. As such, based on this high level of familiarity, when a target location is in Seattle the contextual information provided might be a context map of the block or blocks around the target location. Alternately, it may be determined that no contextual information is needed.

However, if the target location is outside of the Greater Seattle Area, for instance in Spokane, Wash., and it is determined that the user has little to no familiarity with the city of Spokane, but a fair amount of familiarity with Washington State as a whole, the context map may include a map of Washington State indicating the location of Spokane on the map.

Further, if the location is in a different country than the user, for instance if the user is searching for hotels in Aix-en-Provence and the user has little familiarity with France, the context map can display France with an indication of the location of Aix-en-Provence in France. Additionally, cities or locations with which the user has a higher level of familiarity might also be indicated on the context map. For instance, Paris and Nice can be indicated so a user can better understand the location of Aix-en-Provence. Alternately, if it is determined that the user has little familiarity with France, the location of Aix-en-Provence can be provided within a larger context, such as Western Europe, Europe as a whole, or even on a world scale. Alternately, if it is determined that the user is highly familiar with Aix-en-Provence, context information at a similar level to that given for Seattle can be provided, or an appropriate level in between.

Familiarity with the target location can be determined in any of a variety of different manners. For instance, the user's current location, location history, search history, contact addresses, calendar events, social media, photo geotag information, and any other relevant information can be leveraged alone or in combination to determine a user's level of familiarity. For example, if a user walks or drives through an area frequently, if the user has many contacts in an area, or if the user has taken may photos that are geotagged in the location, the user can be determined highly familiar with an area. A user may also be able to manually indicate familiarity with an area.

A context map can be provided in a multitude of situations. For instance, in a mapping application, a user can search for a particular restaurant. While the mapping application has a default zoom level, this may not provide desired context about the location to the user. For instance, if the user is highly familiar with the area, it would be useful to the user to have one block or a few surrounding blocks in order for the user to orient themselves based on familiar nearby restaurants or landmarks. If the user is unfamiliar with the area, the default zoom level of the mapping application may provide little useful information to the user, and the context map can provide the location of the restaurant at a different scale, for example it might display a neighborhood level map if the user is familiar with the neighborhood, a city level map if the user is unfamiliar with the neighborhood, but familiar with other parts of the city, or a state, province, country, world or other larger scale map to indicate the location of the city in which the restaurant is located.

A context map can also be provided in a variety of alternate scenarios. One example is video or textual messaging scenarios. For instance, if participants in a messaging group are located in different cities or countries a context map might be provided to show the locations of the participants. Alternately, a context map could be provided in relation to an email, instant messaging, video, SMS, or other types of communication. Information about time zones may further be included in these maps. Other scenarios that would benefit from a context map include web browsing, e-books, virtual and augmented reality.

The techniques discussed herein provide context information to the user, such as with a context map, based on the user's familiarity with the area in which a target location is located. This improves usability of a device, allowing the user to quickly and easily understand where the target location is located. This also reduces or eliminates the user spending time zooming in and/or zooming out on a map where the target location is displayed, which can reduce usage of, and thus energy usage of, the device. The reduced zooming in and/or zooming out can also reduce the amount of data bandwidth used by the device due to obtaining data to display the results of the zooming in and/or zooming out.

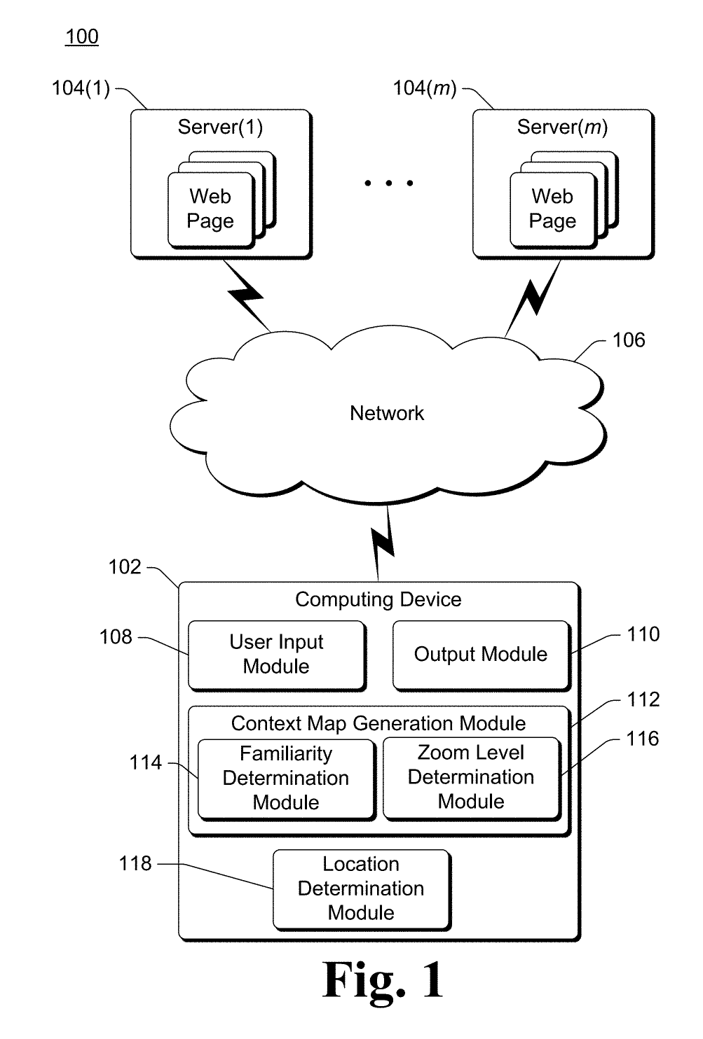

FIG. 1 illustrates an example system 100 implementing the providing map context in accordance with one or more embodiments. System 100 includes a computing device 102 that can communicate with one or more (m) servers 104 via a network 106. Network 106 can be a variety of different networks, including the Internet, a local area network (LAN), a public telephone network, an intranet, other public and/or proprietary networks, combinations thereof, and so forth.

Computing device 102 can be a variety of different types of devices, such as a desktop computer, a server computer, a laptop or netbook computer, a mobile device (e.g., a tablet or phablet device, a cellular or other wireless phone (e.g., a smartphone), a notepad computer, a mobile station), a wearable device (e.g., eyeglasses, head-mounted display, watch, bracelet, augmented reality (AR) devices, virtual reality (VR) devices), an entertainment device (e.g., an entertainment appliance, a set-top box communicatively coupled to a display device, a game console), Internet of Things (IoT) devices (e.g., objects or things with software, firmware, and/or hardware to allow communication with other devices), a television or other display device, an automotive computer, and so forth. Thus, computing device 102 may range from a full resource device with substantial memory and processor resources (e.g., personal computers, game consoles) to a low resource device with limited memory and/or processing resources (e.g., traditional set-top boxes, hand-held game consoles).

Servers 104 can be a variety of different computing devices capable of hosting Web pages that can be retrieved and displayed the computing device 102. Similar to the discussion of computing device 102, servers 104 can be a variety of different devices, ranging from full resource devices with substantial memory and processor resources to low resource devices with limited memory and/or processing resources. Different servers 104 can be the same or different types of devices.

User input module 108 receives user inputs from a user of computing device 102. User inputs can be provided in a variety of different manners, such as by pressing one or more keys of a keypad or keyboard of computing device 102, pressing one or more keys of a controller (e.g., remote control device, mouse, trackpad, etc.) of computing device 102, pressing a particular portion of a touchpad or touchscreen of computing device 102, making a particular gesture on a touchpad or touchscreen of computing device 102, and/or making a particular gesture on a controller (e.g., remote control device, mouse, trackpad, etc.) of computing device 102. User inputs can also be provided via other physical feedback input to computing device 102, such as tapping any portion of computing device 102, an action that can be recognized by a motion detection component of computing device 102 (such as shaking computing device 102, rotating computing device 102, etc.), and so forth. User inputs can also be provided in other manners, such as via audible inputs to a microphone, via motions of hands or other body parts observed by an image capture device, and so forth.

Output module 110 generates, manages, and/or outputs content for display, playback, and/or other presentation. This content can be created by output module 110 or obtained from other modules of computing device 102. This content can be, for example, a display or playback portion of a user interface (UI). The content can be displayed or otherwise played back by components of computing device 102 (e.g., speakers, interactive display devices, etc.). Alternatively, output module 110 can generate one or more signals that are output to other devices or components (e.g., speakers, display devices, etc.) that are separate from computing device 102.

Computing device 102 includes a context map generation module 112 that includes a familiarity determination module 114 and a zoom level determination module 116. The context map generation module 112 receives an indication of a target location. The indication can be received from the user input module 108, can be determined by analyzing content from the output module 110, can be received from an external device, or can be received in any other desired manner. The context map generation module 112 provides a context map for the target location at a zoom level determined based on the user's familiarity with the target location.

In one or more embodiments, the context map generation module 112 determines if a user and target location are in a same bounded area (e.g., a city, state, country, etc.) and thus that the context map is to be displayed at a zoom level that shows that bounded area. Additionally or alternatively, more information can be included in determining the zoom level as discussed below.

Familiarity determination module 114 uses data available to it in order to determine the user's familiarity with a target location. Familiarity determination module 114 can use data including the user's current location, location history, search history, contact addresses, calendar events, social media, photo geotag information, and any other relevant information. The user's familiarity with a target location is a level, score, or value indicating how knowledge the familiarity determination module 114 deems the user to be regarding the target location. The determined familiarity may correspond to levels such as: “Not familiar” “Somewhat familiar” “familiar” “very familiar” and “extremely familiar”. Alternately, the familiarity determination module 114 can determine familiarity as a degree, a percentage, “yes” or “no”, or in any other desired way.

Zoom level determination module 116 receives the familiarity determined by the familiarity determination module 114 and uses the determined familiarity to determine a zoom level that will provide the user with useful context for the target location. Zoom level determination module 116 can also leverage existing map features such as city, state, and country outlines, rivers, roads, and any other data included in map data to provide a useful map. The zoom level determination module 116 can determine that the zoom level is one of any number of set zoom levels (e.g., country, state, city, etc.), is a certain radius around the target location (e.g., a particular number of blocks or miles), is to include certain other locations, or any other desired zoom level.

Location determination module 118 is used to determine the location of the user. This may comprise any technologies such as the Global Positioning System (GPS), the Global Navigation Satellite System (GLONASS), the BeiDou (or Compass) navigation system, the Galileo positioning system, combinations thereof, and so forth. The location determination module 118 may maintain a record of locations visited by the user (e.g., by the computing device 102) as well as indications of when (e.g., time and/or date) those locations were visited by the user.

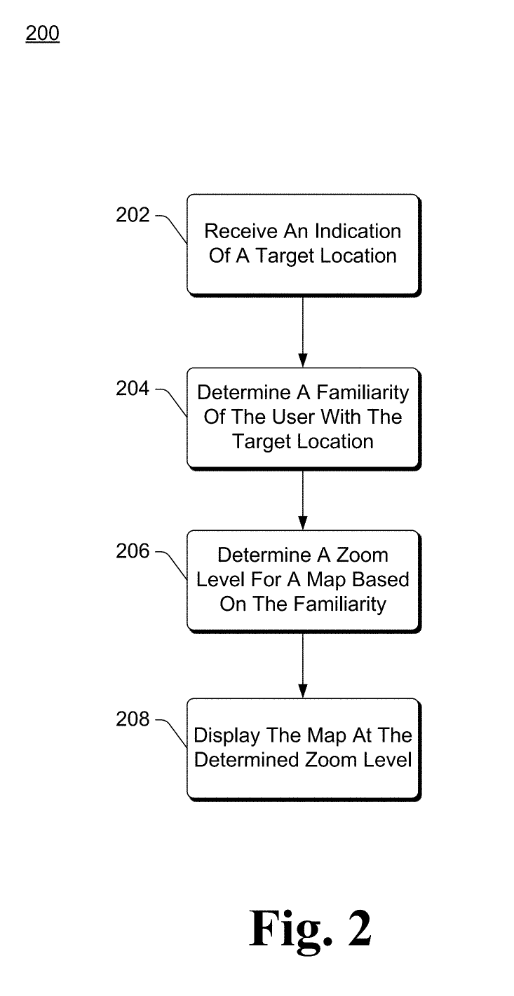

FIG. 2 is a flowchart illustrating an example process 200 for providing map context in accordance with one or more embodiments. Process 200 is carried out by a device such as computing device 102 of FIG. 1, and can be implemented in software, firmware, hardware, or combinations thereof. Process 200 is shown as a set of acts and is not limited to the order shown for performing the operations of the various acts. Process 200 is an example process for providing map context; additional discussions of providing map context are included herein with reference to different figures.

In process 200, an indication of a target location is received (act 202). The indication can be received by the user input module 108 in the form of a typed input by a user, selection of a location from a list or map, a spoken input, a gesture, or any other method of user input. Alternately, the target location may be identified from content presented or detected by the computing device 102 such as a web page, e-book, physical media, or advertisement with or without user input. For instance, if a user is reading an e-book and a location is mentioned, the user might hover, click or otherwise select the location. Alternately, the computing device may automatically detect the location name within the text.

The familiarity of the user with the target location is then determined (act 204). The familiarity of the user with the target location can be determined in a variety of different manners, and using a variety of different data. For instance, the user's current location as determined by the location determination module 118 or other location determination method can be leveraged. In one or more embodiments, if the user is currently in a city, the user is determined to be familiar with that city. Alternately, or in addition, a degree of familiarity can be determined by further leveraging the user's location history. Accordingly, if a user has recently (e.g., within a threshold amount of time, such as 2 weeks) been in the city, or has historically spent a lot of time within the city (e.g., spent a threshold amount of time in the city, such as 10 days over the previous 6 months), the user can be determined to have a higher degree of familiarity than a user who has not been to the city recently, or who has not spent much or any time previously in the city. Further, the familiarity can be gauged as a function of both the recency and amount of time the user has spent in an area, such that a user who visited a city for a weekend ten years ago is determined to be less familiar with the city than a user who spent last weekend in the city. The user's familiarity can be determined in various manners, such as through historic GPS data, geotagged photographs, check-ins and other data from social media, calendar event locations, contact addresses, search history, and any other relevant information.

In one or more embodiments, determining the familiarity of the user comprises determining if the user's familiarity with a surrounding area such as an area within a certain distance of the target location (e.g. 5 miles or 5 city blocks), a defined entity (e.g. a neighborhood, district, town, city, county, state, etc.) or any other method of determining a surrounding area.

A zoom level for a map based on the familiarity is then determined (act 206). For instance, if the user is determined to be familiar with the target location, the zoom level can be determined to show the city. Alternately, if the user is determined to be very familiar, the zoom level could be the neighborhood, few blocks, the street, or a set radius.

In one or more embodiments the following rules are used to set the zoom level for a map. If the user is determined to currently be in the same city as the target location and within a threshold distance (e.g., 50 miles) of the target location, the zoom level is determined to be “neighborhood”. If the user is determined to currently be in the same city as the target location and not within a threshold distance (e.g., 50 miles) of the target location, the zoom level is determined to be “city”. If the user is determined to currently be in the same state but outside of the same city as the target location the zoom level is determined to be “state”. If the user is determined to currently be in the same country but outside of the same state as the target location the zoom level is determined to be “state”. If the user is determined to currently be in a different country than the target location the zoom level is determined to be “country”. Thus, using this example, the zoom level ranges from “neighborhood” (the finest granularity or level) to “country” (the coarsest granularity or level).

Alternatively, if the user's current location is determined to be in a state proximate to that of the target location (e.g., within a threshold distance, such as 400 miles), the zoom level can be determined to be “state”. For instance, a user in Seattle, Wash. could be determined to be more familiar with the geography of Oregon or Idaho and recognize the outline of the state, whereas the user might not have that level of familiarity with Virginia. As such, when the user searches for a target location in Oregon, the zoom level can be determined to be “state” whereas if the user searches for a target location in Virginia the zoom level can be determined to be “country” or “multiple states”. Similarly, if the user enters a target location in France, the zoom level can be determined to be “country” or “multiple countries” or “continent” or “world”.

If the user is determined to be highly familiar with an area, but is not currently located near the area, the zoom level can be determined based on information other than current location. For instance, the user in Seattle might frequently travel in France, and have multiple French contacts with whom the user regularly communicates. Accordingly, when this user searches in France, the determined zoom level might be “region” or “city” rather than “country”. More discussion of the zoom levels can be found below with reference to the subsequent figures.

In one or more embodiments, the determined zoom levels of “neighborhood”, “city”, “state”, and “country” that are determined based on the current location of the user and the target location as discussed above are adjusted down one level based on contacts the user has in or near the target location. The contacts of the user can be determined in various manners, such contacts listed in an address book or email address list of the user, contacts (e.g., friends) that are listed as part of a social media account, and so forth. For example, if the user has at least a threshold number (e.g., 3) of friends who live in France, then if the target location is in a city in France and the rules otherwise indicate that the zoom level is “country”, then the zoom level is adjusted down to “state” due to the contacts that the user has in France. However, if the target location is in a city in Ireland and the user has no contacts that live in Ireland, then if the target location is in a city in Ireland and the rules otherwise indicate that the zoom level is “country”, then the zoom level remains “country”.

By way of another example, if the user has at least a threshold number (e.g., 3) of friends who live in Washington, then if the target location is in a city in Washington and the rules otherwise indicate that the zoom level is “state”, then the zoom level is adjusted down to “city” due to the contacts that the user has in Washington. By way of yet another example, if the user has at least a threshold number (e.g., 3) of friends who live in Seattle, Wash., then if the target location is in Seattle, Wash. and the rules otherwise indicate that the zoom level is “city”, then the zoom level is adjusted down to “neighborhood” due to the contacts that the user has in Seattle, Wash.

The map is then displayed at the determined zoom level (act 208). In one or more embodiments, the map is displayed by overlaying a context map on base content. The base content can be a map displayed at a default zoom level. The context map can be displayed over a portion of the map, for instance in a corner or centered over the map. Alternatively, the context map can be displayed in a split screen with the base content (e.g., adjacent to but no overlaying the base content). In one or more embodiments, the context map overlay is displayed as long as the user is utilizing the base content, until a time out period expires (e.g., 30 seconds), or no user input requesting to close the context map is received.

Alternatively, the base content can be a content displayed by a messaging application or web-based messaging, the messaging could be video, picture, text, email, or any combination thereof. For instance, in a group chat, the context map might be displayed to show where individual participants in the group chat are located. The context map might display each participant on a single map or alternately multiple context maps can be used to display the participants' locations. The base content can alternatively be any sort of content displayed by a web page, e-book, weather application, advertisement, physical media, video, or any other medium consumable on or through a computing device. For instance, the base content can be content displayed as part of a virtual or augmented reality display. Alternatively, the context map can be presented as part of a second screen experience (e.g., the base content displayed on one screen and the context map displayed on another screen).

In one or more embodiments, the base content is itself a map (e.g., from a mapping application) that is displayed at the determined zoom level (as determined in act 206). Thus, rather than displaying a context map concurrently with the base content map, the base content map itself is displayed at the determined zoom level. This display of the base content map at the determined zoom level can be maintained for a threshold amount of time (e.g., ten seconds), and then the base content map is zoomed to the default zoom level. For example, assume the default zoom level is the neighborhood zoom level and the determined zoom level is the state zoom level, base content map can initially be displayed at the state zoom level, then changed to the neighborhood zoom level after a threshold amount of time (e.g., ten seconds) has elapsed.

Alternatively, in some situations a context may not be displayed (e.g., a context map may not be displayed or the base content may be a map displayed at the default zoom level rather than the determined zoom level). The determination can be made to not display the context in various situations, such as the same target location has been frequently displayed to the user. For example, if the base content has displayed the target location at least a threshold number of times (e.g., twenty times, or ten times in the preceding week), then it can be determined that the user is already familiar with the target location and no context (e.g., no context map) need be displayed.

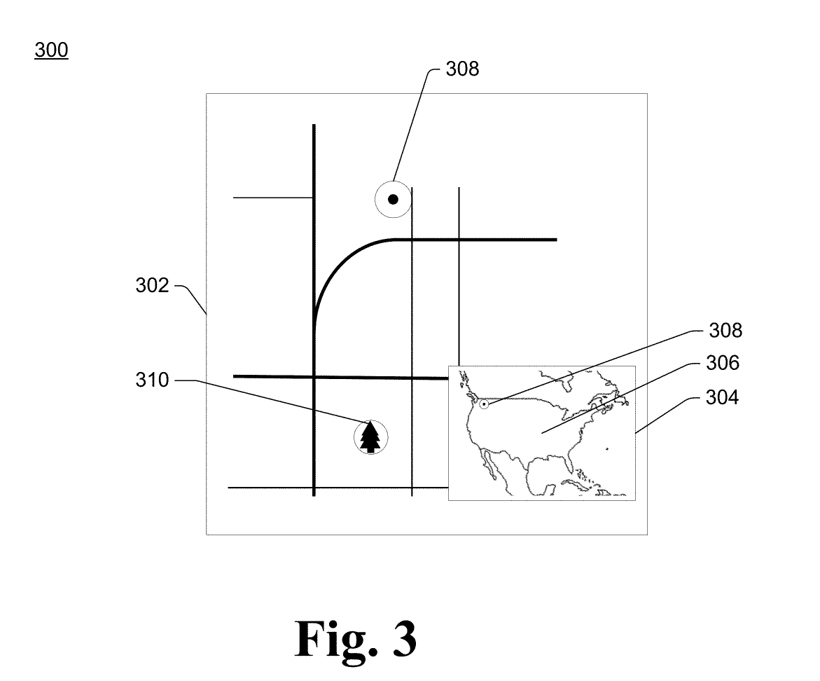

FIG. 3 illustrates an example embodiment of providing a context map. This user interface 300 could be displayed in a multitude of situations. User interface 300 comprises base content 302 in the form of a map, and context map 304 in the lower right corner. In this instance, the context map 304 displays an outline of the United States 306. Both the base content 302 and the context map 304 include a target location marker 308 that identifies the target location. The target location marker 308 can take any desired form, such as a colored dot, arrow, highlighted area, or other indicia. The base content 302 also includes an indication of other locations 310 displayed at the default display level. The default zoom level for the base content 302 can be a zoom level determined when the base content 302 is generated and may correspond to a set radius, granularity, or level of detail.

User interface 300 may be displayed if the target location is located in Spokane, Wash. and the user is determined to have little familiarity with Spokane, Wash. Further, the user is determined to have little familiarity with the states of Washington, Oregon, or Idaho. This determining might be completed by analyzing the user's location history and determining that the user has not visited any of Washington, Oregon, or Idaho, or has visited locations in Washington, Oregon, or Idaho for less than a threshold amount of time, or traveled less than a threshold amount of time or distance within the area. These thresholds can be a set amount of time, such as two hours or two miles. The location history can also be correlated with flight reservation emails or other data to determine, for instance, that the user simply had a layover in an airport in Spokane, Wash. and therefore is not familiar with the area.

It may be determined that the user is familiar with parts of Canada or Mexico, and thus the context map 304 displays the target location marker 308 within the outline of the United States 306 with parts of Canada and Mexico indicated in order to provide the user with useful context for the target location. If, however, the user in not familiar with Canada or Mexico, those countries can appear shaded (or otherwise differentiated) in order to indicate that they are not related to the target location. Any amount of the context map 304 can be shaded, for instance, everything except the state in which the target location is located.

Alternately, the user's search history may indicate that he or she is planning a trip with destinations across the US and might be familiar with various different locations in the US. It is considered that locations other than the target location could be indicated on the context map 304, such as by displaying markers for recently searched for locations in order to allow the user to orient the target location marker 308 with other familiar locations, displaying markers for well-known locations such as capital cities, monuments, other landmarks, and so forth. These markers can be visibly different from the target location marker 308, such as being a different color, shape, or size.

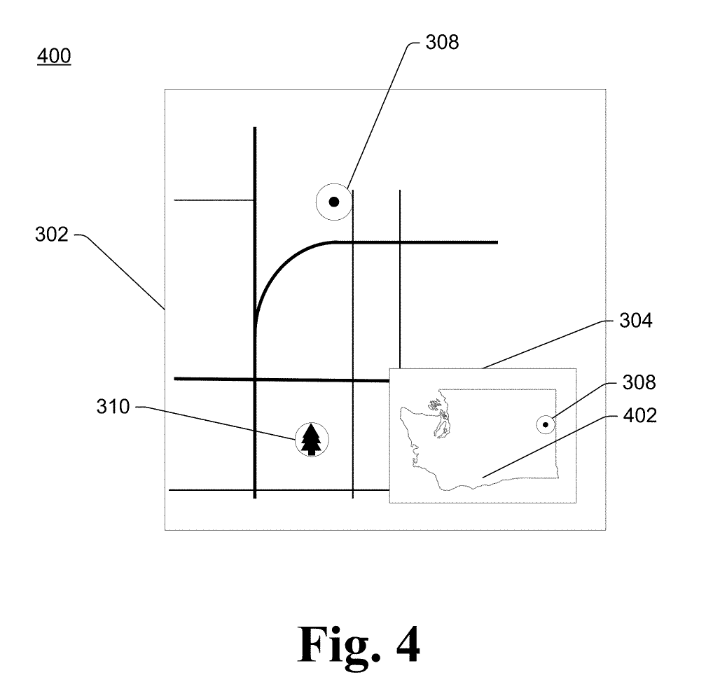

FIG. 4 illustrates another example embodiment of providing a context map. This user interface 400 can be displayed in a multitude of situations. User interface 400 comprises the base content 302 in the form of a map, and the context map 304 in the lower right corner. In this instance, the context map 304 displays an outline of Washington State 402. Both the base content 302 and the context map 304 include the target location marker 308. The base content 302 also includes an indication 310 of other locations displayed at the default display level. The default zoom level for the base content 302 can be a zoom level determined when the map of the base content 302 is generated and may correspond to a set radius, granularity, or level of detail.

Take, for instance, a user in Seattle, Wash. entering a search for a target location in Spokane, Wash. The context map generation module 112 gathers data that indicates that the user is located in Seattle. Further, the location history data may indicate that the user lives in Seattle, and has traveled in Washington State, but has spent less than a threshold amount of time (e.g., ten days, five days over the past 6 months, etc.) in Spokane. Accordingly, the context map generation module 112 determines that the context map zoom level is “state” and displays the context map 304 with the target location marker 308 appropriately placed within the outline of Washington State 402.

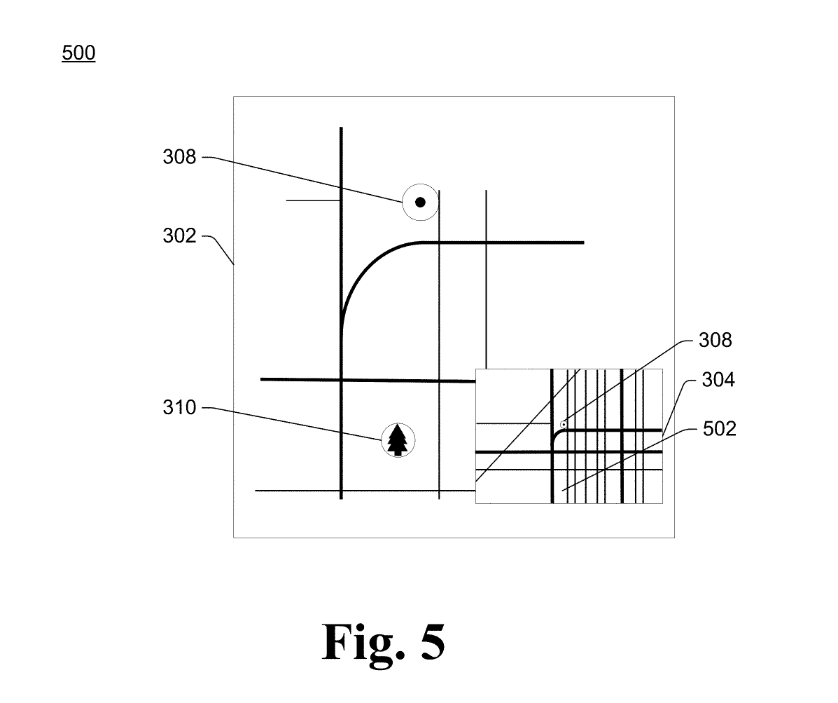

FIG. 5 illustrates another example embodiment of providing a context map. This user interface 500 could be displayed in a multitude of situations. User interface 500 comprises the base content 302 in the form of a map, and context map 304 in the lower right corner. In this instance, the context map 304 displays a city view 502 which includes the streets surrounding the target location marker 308. The zoom level displayed in context map 304 could be called “city”. It might additionally include an outline of city or neighborhood boundaries and may display one or more cities or neighborhoods as determined by the zoom level determination module 116.

It is considered that the context map 304 at the “city” zoom level might include indications of map features such as parks, restaurants, schools, hospitals, and so on. These map features could be the same as those displayed on the base content map 302, or could be different, for example including showing fewer or additional map features, or showing map features specifically determined to be familiar to the user. It is considered that map features can be included on the context map at any zoom level.

The displaying the target location marker within city view 502 zoom level of context map 304 can be selected for a user who is currently in the same city as the target location. Additionally or alternatively, the user could be determined to have a high level of familiarity with the area surrounding the target location.

For instance, a user currently located in Spokane, Wash., whose location history indicates that he or she likely lives in Spokane, Wash. can be determined to be highly familiar with Spokane, Wash. As such, the zoom level determination module 116 determines that the zoom level for context map 304 is “city” and thus the context map 304 displays the target location marker 308 on a city view 502.

Alternatively, consider a user whose current location is Los Angeles, Calif. The location data of the user indicates that she has not been to Spokane, Wash. recently, but it is determined that she has multiple contacts with addresses in Spokane, Wash. The familiarity determination module 114 can determine that these contacts include “Mom,” or that the user frequently communicates (e.g., calls, emails, messages at at least a threshold frequency, such as twice per week or once per day) with one or more of the contacts with addresses in Spokane, Wash. Additionally, the familiarity determination module 114 might leverage a social media profile that lists “Spokane, Wash.” as the user's hometown, might determine that the user follows local news in Spokane based off the user's search history, or the user may have entered a familiarity rating or indication for Spokane. Accordingly, even though the user's current location is outside of Spokane, the familiarity determination module 114 can determine that the user is highly familiar with the area surrounding the target location and display the target location marker 308 in the city view 502.

Further, the context map may include indications of locations associated with the user's contacts. These locations may include addresses from the contacts' profiles, their current locations, check-ins, favorites, places they've reviewed and any other relevant locations. These indications can be displayed on the context map 304 and are preferably visibly different than the target location marker 308. It is also considered that these locations associated with the user's contacts could be overlaid or included on the base content map 302 instead of, or in addition to being displayed on the context map 304.

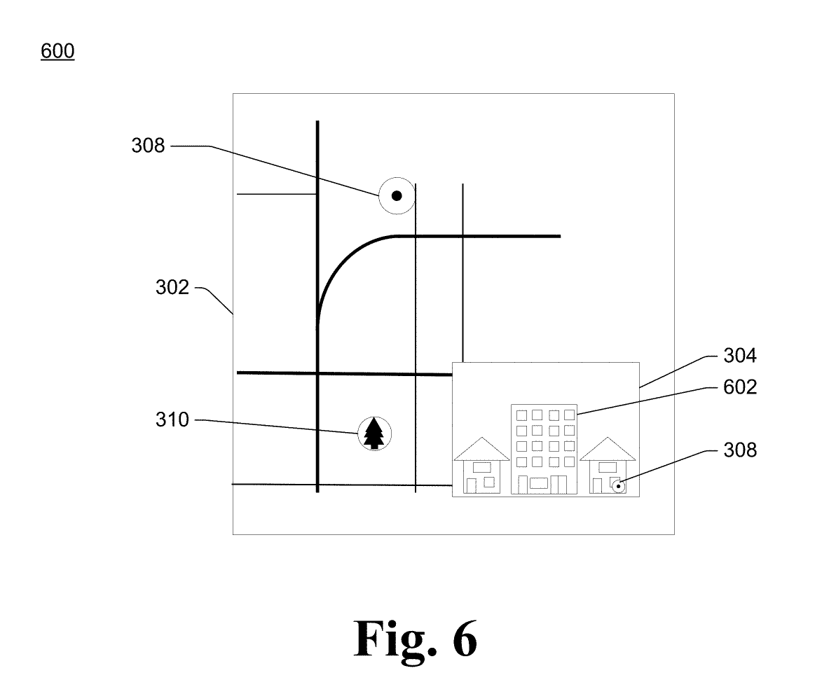

FIG. 6 illustrates another example embodiment of providing a context map. This user interface 600 could be displayed in a multitude of situations. User interface 600 comprises the base content 302 in the form of a map, and context map 304 in the lower right corner. In this instance, the context map 304 displays a streetside view 602 of the target location, and the target location marker 308 is displayed on the streetside view. The streetside view 602 might be a photo, illustration, or other rendering of the target location and its immediate surroundings. Immediate surroundings can include locations within a few buildings, or a set distance (e.g. one city block, 500 feet, 3 doors, etc.).

If a user is determined to be extremely familiar with the target location and/or the surrounding area, the zoom level might be determined to be the “street” zoom level and the streetside view 602 can be displayed as the context map 304. The “street” zoom level might allow the user to determine which building of a group of buildings is the target location. The “street” zoom level is a zoom level lower or of a finer granularity than the “neighborhood” zoom level.

For instance, consider a user whose location history or purchase history indicates that she frequently visits a coffee shop and the target location is within the immediate surroundings of the coffee shop. The user may find the target location marker 308 displayed in the streetside view 602 useful for the context map 304 to show in order to know that the target location is to the left of the frequented coffee shop.

The context map 304, or any of the context maps previously discussed, may be user selectable. This can include moving the context map 304 to a different location in the user interface 600, changing the displayed size of the context map 304, selecting the context map zoom level to be displayed as the base content 302 rather than the default zoom level, or any other user interactions.

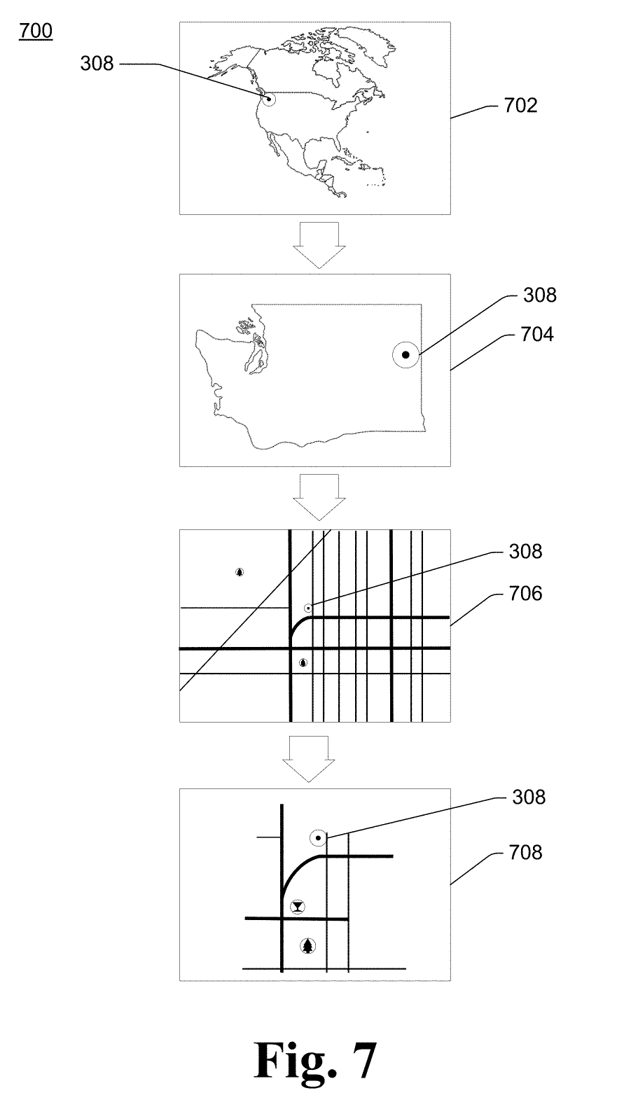

FIG. 7 illustrates another example embodiment 700 of providing a context map. Embodiment 700 comprises a flow of screens in order to provide context to a map display. The screens 702-708 can be shown in succession, as part of a zoom animation, or in any other manner. As previously described, the familiarity determination module 114 determines how familiar the user is with the target location. The zoom level determination module 116 determines an appropriate zoom level. In embodiment 700, the determined zoom level is “continent” and accordingly outline of North America is displayed by screen 702 with the target location marker 308 displayed to indicate the target location. The successive screens 704-708 representing different possible zoom levels and including the target location marker 308 are then displayed until the default zoom level is reached. Thus, as shown in FIG. 7, a map at the “continent” zoom level (a coarser or higher granularity than the “country” zoom level) is displayed by screen 702, a map at the “state” zoom level is displayed by screen 704, a map at the “city” zoom level is displayed by screen 706, and a map at the “neighborhood” zoom level is displayed by screen 708. The maps displayed by screens 702-708 can be context maps displayed along with the base content, or alternatively can be the base content (e.g., a map provided by a mapping application).

It should be noted that the determined zoom level can be any zoom level as discussed above, for instance rather than starting at screen 702, the first screen could be screen 704. The determined zoom level is displayed and then zoomed in or out until the default zoom level is reached.

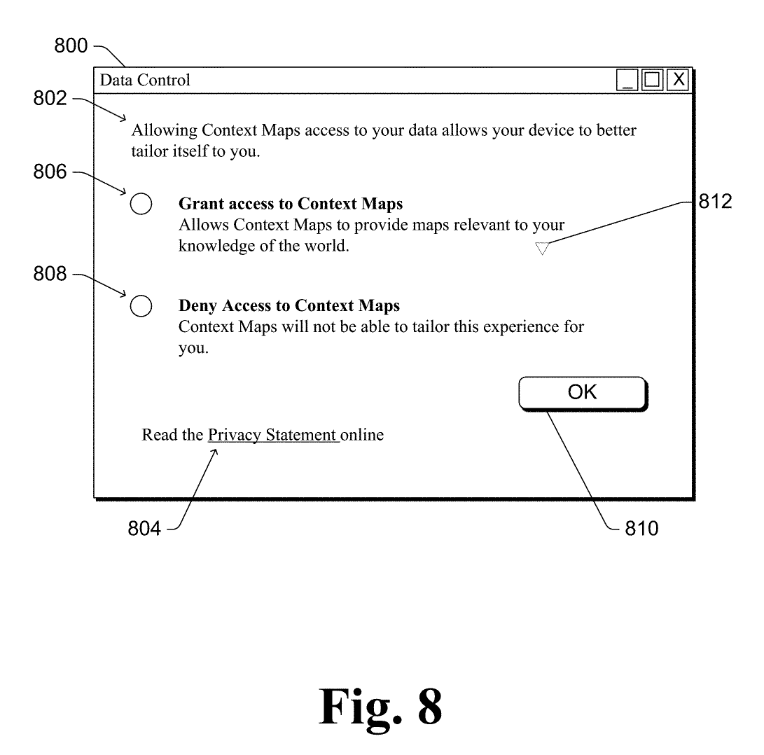

FIG. 8 illustrates an example user interface that can be displayed to a user to allow the user to select whether context map generation module 112 will use their data to provide personalized context maps. A data control window 800 is displayed including a description 802 explaining to the user why the context map generation module 112 is requesting access to the data. A link 804 to a privacy statement is also displayed. If the user selects link 804, a privacy statement of the service using the context map generation module 112 is displayed, explaining to the user how the user's information is kept confidential.

Additionally, the user is able to select a radio button 806 to opt-in to the data usage, or a radio button 808 to opt-out of the data usage. Once a radio button 806 or 808 is selected, the user can select an “OK” button 810 to have the selection saved. Additionally, the user can select an expander button 812 to further control data usage. It is to be appreciated that radio buttons and an “OK” button are only examples of user interfaces that can be presented to a user to opt-in or opt-out of the data usage, and that a variety of other conventional user interface techniques can alternatively be used. Context map generation module 112 then proceeds to use or not use the user's data in accordance with the user's selection.

Furthermore, it should be noted that the usage of data can allow the context map generation module 112 to distinguish between different users, but need not include any personal information identifying particular users. For example, a user or user's device may log in with a particular user name or identity, but no association between that user name and the actual person need be maintained. This further allows the context map generation module 112 to connect a user profile used across multiple devices. Accordingly, the context map generation module 112 can leverage information from multiple device used by the user with that particular user name, and at the same time have no knowledge of who that user actually is.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

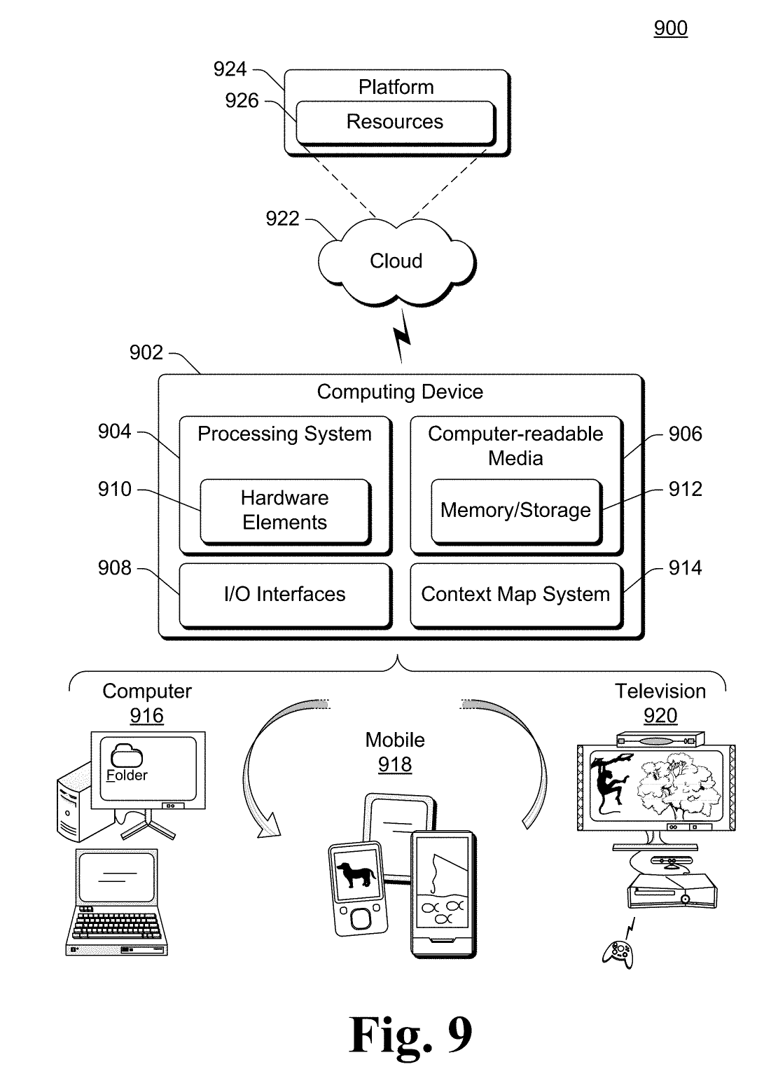

FIG. 9 illustrates an example system generally at 900 that includes an example computing device 902 that is representative of one or more systems and/or devices that may implement the various techniques described herein. The computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O Interfaces 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware elements 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 906 is illustrated as including memory/storage 912. The memory/storage 912 represents memory/storage capacity associated with one or more computer-readable media. The memory/storage 912 may include volatile media (such as random access memory (RAM)) and/or nonvolatile media (such as read only memory (ROM), Resistive RAM (ReRAM), Flash memory, optical disks, magnetic disks, and so forth). The memory/storage 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

The one or more input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 902 may be configured in a variety of ways as further described below to support user interaction.

Computing device 902 also includes a context map system 914. Context map system 914 provides various functionality providing map context as discussed herein. Context map system 914 can be, for example, context map generation module 112 of FIG. 1.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 910 and computer-readable media 906 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of modules as a module that is executable by the computing device 902 as software may be achieved at least partially in hardware, e.g., through use of computer-readable storage media and/or hardware elements 910 of the processing system. The instructions and/or functions may be executable/operable by one or more articles of manufacture (for example, one or more computing devices 902 and/or processing systems 904) to implement techniques, modules, and examples described herein.

As further illustrated in FIG. 9, the example system 900 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 900, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 902 may assume a variety of different configurations, such as for computer 916, mobile 918, and television 920 uses. Each of these configurations includes devices that may have generally different constructs and capabilities, and thus the computing device 902 may be configured according to one or more of the different device classes. For instance, the computing device 902 may be implemented as the computer 916 class of a device that includes a personal computer, desktop computer, a multi-screen computer, laptop computer, netbook, and so on.

The computing device 902 may also be implemented as the mobile 918 class of device that includes mobile devices, such as a mobile phone, portable music player, portable gaming device, a tablet computer, a multi-screen computer, and so on. The computing device 902 may also be implemented as the television 920 class of device that includes devices having or connected to generally larger screens in casual viewing environments. These devices include televisions, set-top boxes, gaming consoles, and so on.

The techniques described herein may be supported by these various configurations of the computing device 902 and are not limited to the specific examples of the techniques described herein. This functionality may also be implemented all or in part through use of a distributed system, such as over a “cloud” 922 via a platform 924 as described below.

The cloud 922 includes and/or is representative of a platform 924 for resources 926. The platform 924 abstracts underlying functionality of hardware (e.g., servers) and software resources of the cloud 922. The resources 926 may include applications and/or data that can be utilized while computer processing is executed on servers that are remote from the computing device 902. Resources 926 can also include services provided over the Internet and/or through a subscriber network, such as a cellular or Wi-Fi network.

The platform 924 may abstract resources and functions to connect the computing device 902 with other computing devices. The platform 924 may also serve to abstract scaling of resources to provide a corresponding level of scale to encountered demand for the resources 926 that are implemented via the platform 924. Accordingly, in an interconnected device embodiment, implementation of functionality described herein may be distributed throughout the system 900. For example, the functionality may be implemented in part on the computing device 902 as well as via the platform 924 that abstracts the functionality of the cloud 922.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method comprising: receiving, at a computing device, an indication of a target location; determining a familiarity of a user of the computing device with an area surrounding the target location; determining a zoom level for a map based on the familiarity of the user with the area around the target location; displaying the map with the determined zoom level.

Alternatively or in addition to any of the above described methods, any one or combination of: wherein the determining the familiarity of the user comprises at least one of determining a recency with which the user has visited the target location, determining an amount of time the user has spent in the area surrounding the target location, and determining a current location of the user; wherein the determining the familiarity of the user comprises analyzing at least one of the user's photos, calendar events, or contacts for location data associated with the area surrounding the target location; wherein the determining the familiarity of the user comprises determining the user is one of multiple levels of familiar with the area surrounding the target location; wherein the displaying the map with the determined zoom level comprises displaying a target location marker on the map; the method further comprising displaying an additional marker on the map indicating another location; wherein the determining the zoom level for the map comprises determining that the user and the target location are in a same bounded area, and determining the zoom level to be the bounded area; wherein the map is overlaid on a first content; wherein the first content is an additional map; wherein the first content is content displayed by one of a messaging application, a web page, an e-book, or a weather application; the method further comprising zooming the map from the determined zoom level to a default zoom level.

A system comprising: one or more processors; and one or more computer-readable storage medium having stored thereon multiple instructions that, responsive to execution by the one or more processors, cause the one or more processors to: receive an indication of a target location; determine a familiarity of a user with an area surrounding the target location; determine, based on the familiarity of the user with the area, a zoom level for a map including the target location; display the map at the determined zoom level.

Alternatively or in addition to any of the above described computing devices, any one or combination of: wherein the indication is received through user input; wherein the indication is received through analyzing content; wherein the area surrounding the target location is a radius around the target location; wherein the area surrounding the target location is a neighborhood, district, or street; wherein the map is presented as an overlay on displayed content; wherein the displayed content is an additional map; wherein the determining the familiarity of the user comprises determining a current location of the user.

A device comprising: an input module configured to receive a target location; a familiarity determination module configured to determine a familiarity of a user with the target location; a zoom level determination module configured to receive the familiarity of the user and determine a zoom level for a map; and a display module configured to display the map at the zoom level.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving, at a computing device, an indication of a target location;
determining a familiarity of a user of the computing device with an area surrounding the target location;
determining a zoom level for a map based on the familiarity of the user with the area around the target location;
displaying the map with the determined zoom level.

2. The method as recited in claim 1, wherein the determining the familiarity of the user comprises at least one of determining a recency with which the user has visited the target location, determining an amount of time the user has spent in the area surrounding the target location, and determining a current location of the user.

3. The method as recited in claim 1, wherein the determining the familiarity of the user comprises analyzing at least one of the user's photos, calendar events, or contacts for location data associated with the area surrounding the target location.

4. The method as recited in claim 1, wherein the determining the familiarity of the user comprises determining the user is one of multiple levels of familiar with the area surrounding the target location.

5. The method as recited in claim 1, wherein the displaying the map with the determined zoom level comprises displaying a target location marker on the map.

6. The method as recited in claim 5, further comprising displaying an additional marker on the map indicating another location.

7. The method as recited in claim 1, wherein the determining the zoom level for the map comprises:
determining that the user and the target location are in a same bounded area; and
determining the zoom level to be the bounded area.

8. The method as recited in claim 1, wherein the map is overlaid on a first content.

9. The method as recited in claim 8, wherein the first content is an additional map.

10. The method as recited in claim 8, wherein the first content is content displayed by one of a messaging application, a web page, an e-book, or a weather application.

11. The method as recited in claim 1, further comprising zooming the map from the determined zoom level to a default zoom level.

12. A system comprising:
one or more processors; and
one or more computer-readable storage medium having stored thereon multiple instructions that, responsive to execution by the one or more processors, cause the one or more processors to:
receive an indication of a target location;
determine a familiarity of a user with an area surrounding the target location;
determine, based on the familiarity of the user with the area, a zoom level for a map including the target location;
display the map at the determined zoom level.

13. The system as recited in claim 12, wherein the indication is received through user input.

14. The system as recited in claim 12, wherein the indication is received through analyzing content.

15. The system as recited in claim 12, wherein the area surrounding the target location is a radius around the target location.

16. The system as recited in claim 12, wherein the area surrounding the target location is a neighborhood, district, or street.

17. The system as recited in claim 12, wherein the map is presented as an overlay on displayed content.

18. The system as recited in claim 17, wherein the displayed content is an additional map.

19. The system as recited in claim 12, wherein the determining the familiarity of the user comprises determining a current location of the user.

20. A device comprising:
an input module configured to receive a target location;
a familiarity determination module configured to determine a familiarity of a user with the target location;
a zoom level determination module configured to receive the familiarity of the user and determine a zoom level for a map; and
a display module configured to display the map at the zoom level.
